(19) United States
(12) Patent Application Publication
(10) Pub. No.: US 2025/0337137 A1
(43) Pub. Date: Oct. 30, 2025

(54) BATTERY CELL TAB WITH FRANGIBLE AREA

(71) Applicant: Ford Global Technologies, LLC, Dearborn, MI (US)

(72) Inventors: Daewon Han, New Hudson, MI (US); Myoungshin Hong, Ann Arbor, MI (US); Chi Paik, Grosse Ile, MI (US)

(21) Appl. No.: 18/649,904

(22) Filed: Apr. 29, 2024

(51) Int. Cl. H01M 50/583; H01M 50/105; H01M 50/178; H01M 50/505; H01M 50/533; H01M 50/534

(52) U.S. Cl. CPC H01M 50/583; H01M 50/105; H01M 50/178; H01M 50/505; H01M 50/533; H01M 50/534; H01M 2220/20

(57) ABSTRACT

A battery assembly includes a pouch containing an electrode structure, and a tab that electrically couples the electrode structure to a device outside the pouch. The tab extends from an interior of the pouch to an outside of the pouch. The tab includes a frangible area. A tab film covers at least the frangible area of the tab.

### TECHNICAL FIELD

This disclosure relates generally to a tab of a pouch-style battery cell and, more particularly, to a tab with a frangible area.

### BACKGROUND

Electrified vehicles include a traction battery pack for powering electric machines and other electrical loads of the vehicle. The traction battery pack includes a plurality of battery cells and various other battery internal components that support electric vehicle propulsion.

### SUMMARY

In some aspects, the techniques described herein relate to a battery assembly, including: a case containing an electrode structure; a tab that electrically couples the electrode structure to a device outside the case, the tab extending from an interior of the case to an outside of the case, the tab including a frangible area; and a tab film covering at least the frangible area of the tab.

In some aspects, the techniques described herein relate to a battery assembly, wherein the frangible area includes a plurality of apertures that extend through a thickness of the tab.

In some aspects, the techniques described herein relate to a battery assembly, wherein each aperture within the plurality of apertures has a diamond-shaped profile.

In some aspects, the techniques described herein relate to a battery assembly, wherein the electrode structure is sealed within the case.

In some aspects, the techniques described herein relate to a battery assembly, wherein the frangible area provides a fuse.

In some aspects, the techniques described herein relate to a battery assembly, wherein the frangible area is completely covered by the tab film.

In some aspects, the techniques described herein relate to a battery assembly, wherein the tab film is polypropylene.

In some aspects, the techniques described herein relate to a battery assembly, wherein the frangible area is sandwiched by the tab film.

In some aspects, the techniques described herein relate to a battery assembly, wherein the device outside the case is a busbar of a traction battery pack.

In some aspects, the techniques described herein relate to a battery assembly, wherein the frangible area includes an array of apertures extending through the tab.

In some aspects, the techniques described herein relate to a battery assembly, wherein the frangible area is configured to rupture in response to a current above a threshold current.

In some aspects, the techniques described herein relate to a battery assembly, wherein the frangible area is configured to rupture to interrupt a flow of current through the tab.

In some aspects, the techniques described herein relate to a battery assembly, wherein the frangible area includes at least one slot opening to a side of the tab.

In some aspects, the techniques described herein relate to a battery assembly, wherein the tab is a positive tab.

In some aspects, the techniques described herein relate to a battery circuit interruption method, including: routing a flow of current through a tab of a battery, the tab connecting an electrode of the battery that is within a case of the battery to an electrical component that is outside the case; and covering a frangible area of the tab with a tab film, the frangible area configured to rupture to disrupt the flow of current through tab in response to an overcurrent condition.

In some aspects, the techniques described herein relate to a battery circuit interruption method, wherein the frangible area is completely covered by the tab film.

In some aspects, the techniques described herein relate to a battery circuit interruption method, wherein the battery is a pouch-style battery.

In some aspects, the techniques described herein relate to a battery circuit interruption method, wherein the frangible area includes an area of the tab having a plurality of apertures.

In some aspects, the techniques described herein relate to a battery circuit interruption method, wherein the plurality of apertures each extend through a thickness of the tab.

In some aspects, the techniques described herein relate to a battery circuit interruption method, wherein the battery is a pouch-style battery.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle according to an exemplary embodiment of the present disclosure

FIG. 2 illustrates a schematic, perspective view of a battery pack from the electrified vehicle of FIG. 1 with a cover removed to show cell stacks within an interior area of the battery.

FIG. 3 illustrates a battery cell from the battery pack of FIG. 2 with a pouch open.

FIG. 4 illustrates the battery cell of FIG. 3 with the pouch closed.

FIG. 5 illustrates a close-up view of an area of FIG. 4 with selected portions cut away to shown a frangible area within a tab of the battery cell.

FIG. 6 illustrates a top view of the area of FIG. 5.

FIG. 7 illustrates a section view at line 7-7 in FIG. 6.

FIGS. 8A and 8B illustrates top and section views of a tab having a frangible area according to another exemplary aspect of the present disclosure.

FIGS. 9A and 9B illustrates top and section views of a tab having a frangible area according to yet another exemplary aspect of the present disclosure.

FIGS. 10A and 10B illustrates top and section views of a tab having a frangible area according to still another exemplary aspect of the present disclosure.

### DETAILED DESCRIPTION

This disclosure details a tab design for a pouch-style battery cell. The tab includes a frangible area that can activate to disrupt a flow of current through the tab. The frangible area is covered to shield the frangible area and prevent inadvertent activation.

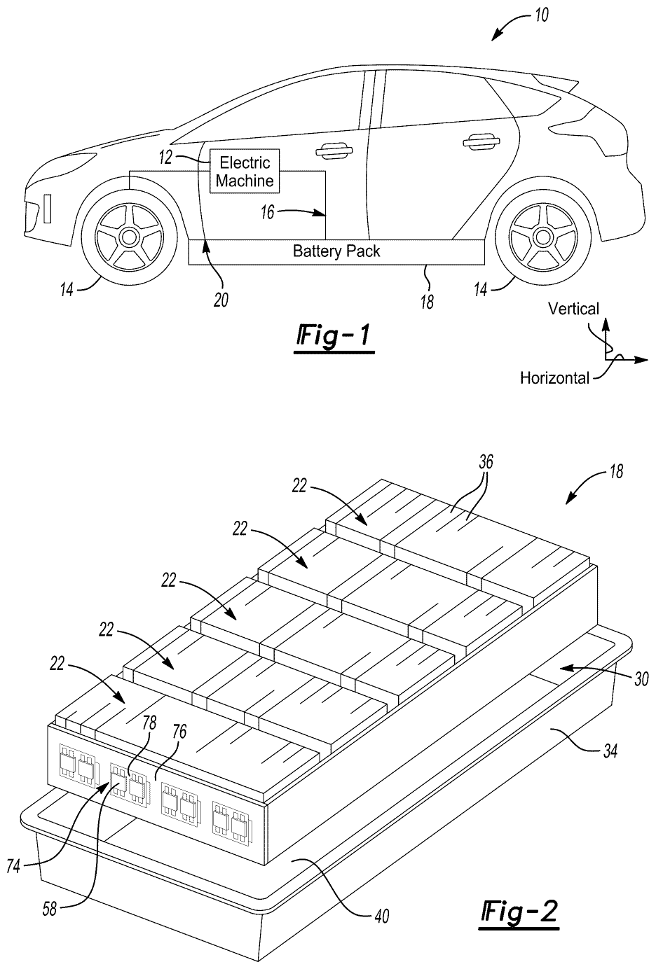

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEVs), etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a car. However, the electrified vehicle 10 could alternatively be a sport utility vehicle (SUV), a van, a pickup truck, or any other vehicle configuration.

Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component, assembly, or system.

In the illustrated embodiment, the electrified vehicle 10 is a full electric vehicle propelled solely through electric power, such as by one or more electric machines 12, without assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 electrically couples the electric machine 12 to a traction battery pack 18. The traction battery pack 18 is a high voltage traction battery pack assembly that includes a plurality of battery cells capable of outputting electrical power to power the electric machine 12 and/or other electrical loads of the electrified vehicle 10.

The example traction battery pack 18 is secured to an underbody 20 of the electrified vehicle 10. However, the traction battery pack 18 could be located elsewhere on the electrified vehicle 10 in other examples.

With reference to FIGS. 2, the traction battery pack 18 includes a plurality of cell stacks 22 housed within an interior area 30 of an enclosure. Here the cell stacks 22 fit within an enclosure tray 34, which can be secured to an enclosure cover, the underbody 20, or both to enclose the cell stacks 22 and other battery internal components within the interior area 30.

Each cell stack 22 includes a plurality of battery cells 36 stacked side-by-side relative to one another along a respective cell stack axis. The cell stacks 22 are disposed on a floor of the enclosure tray 34. A thermal exchange plate (not shown) may be sandwiched between the floor 40 and the cell stacks 22.

In the example embodiment, the battery cells 36 are lithium-ion pouch cells. Battery cells having other geometries and/or chemistries (nickel-metal hydride, lead-acid, etc.) could alternatively be utilized within the scope of this disclosure.

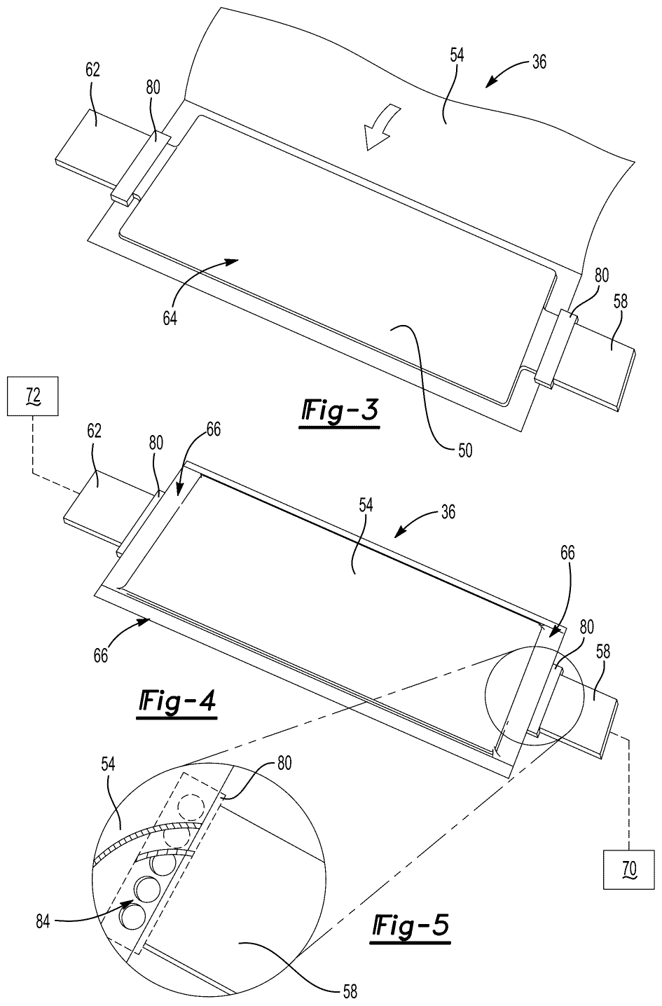

With reference to FIGS. 3 and 4 and continuing reference to FIG. 2, the battery cells 36 include an electrode structure 50 contained within a case 54. A positive tab 58 and a negative tab 62 extend into an interior 64 of the case 54 and are electrically coupled to the electrode structure 50.

The positive tab 58 can connect to a cathode foil of the electrode structure 50. The positive tab 58 can be aluminum, but other materials could be used. The negative tab 62 can connect to an anode foil of the electrode structure 50. The negative tab 62 is copper in this example, but other materials could be used.

The positive tab 58 and the negative tab 62 extend from opposing sides of the case 54 in this example. In another example, the positive tab 58 and the negative tab 62 are on the same side of the case 54.

The case 54 can be a laminated film, such as laminated aluminum film, that is folded over the electrode structure 50 to position the electrode structure 50 within the interior 64 of the case 54. Sides 66 of the case 54 are then sealed to enclose the electrode structure 50 within the interior of the case 54.

The positive tab 58 and the negative tab 62 extend from the electrode structure 50 through the respective side 66 of the case 54 to a position outside the case 54. The positive tab 58 and the negative tab 62 can each connect to another device 70, 72 that is outside the case 54. For example, as shown in FIG. 2, the positive tab 58 can extend through an aperture 74 in a cross-member 76 of the battery pack 18 to connect to a busbar 78 of the battery pack 18. Spot welds could be used to connect the positive tab 58 to the other device 70.

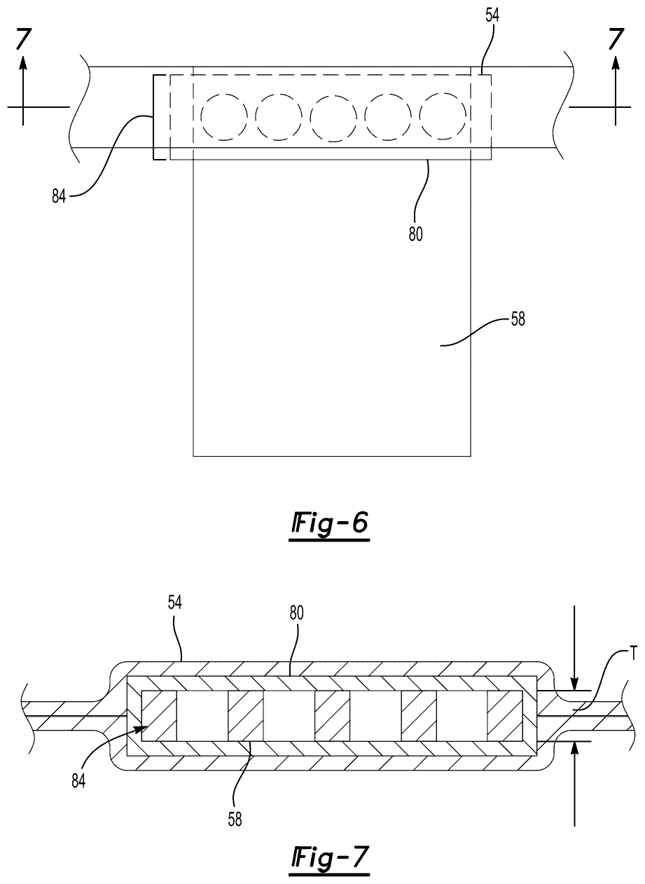

With reference now to FIGS. 5-7 and continuing reference to FIG. 4, the battery cells 36 include a tab film 80 that sandwiches a portion of the positive tab 58 where the positive tab 58 extends through the side 66. The tab film 80 extends circumferentially continuously about and entire perimeter of the positive tab 58. The tab film 80 can be polypropylene. In other examples, the tab film 80 can be polyimide, polyethylene, polyethylene terephthalate, etc.

The tab film 80 facilitates sealing the case 54 where the positive tab 58 extends through the side 66. The sealing provided by the tab film 80 can help to block leakage of an electrolyte, for example, where the positive tab extends through the side 66. The tab film 80 can also prevent short circuits between the positive tab 58 and the case 54.

As can be appreciated, another tab film 80 can be used in connection with the negative tab 62 to seal the case 54 where the negative tab 62 extends through the side 66.

In this example, the positive tab 58 includes a frangible area 84. The frangible area 84 can be a plurality of apertures 88. The apertures 88 can have a diamond-shaped profile, a circular profile, or another profile. In this example, the apertures 88 extend through a thickness T of the positive tab 58. In another example, the apertures 88 extend only partially through the thickness T.

As a flow of current is routed through the positive tab 58, the frangible area 84 will rupture to interrupt a flow of current through the positive tab 58 if an electrical parameter associated within the positive tab 58, such as current levels, exceeds a threshold level. The frangible area 84 thus provides a fuse that ruptures in response to an overcurrent condition. The reduced cross-sectional area of the positive tab 58 in the frangible area 84 can help to focus the rupturing of the positive tab 58.

Notably, the tab film 80 covers the frangible area 84 of the positive tab 58. Covering the frangible area 84 with the tab film 80 can shield the frangible area 84 from an arc in another area of the battery pack 18, for example. Covering the frangible area 84 can help to prevent inadvertent rupturing of the frangible area 84. In this example, the tab film 80 completely covers the frangible area 84.

The positive tab 58 has the frangible area 84 in this example. In another example, the negative tab 62 includes the frangible area 84. In still other examples, both the positive tab 58 and the negative tab 62 include the frangible area 84.

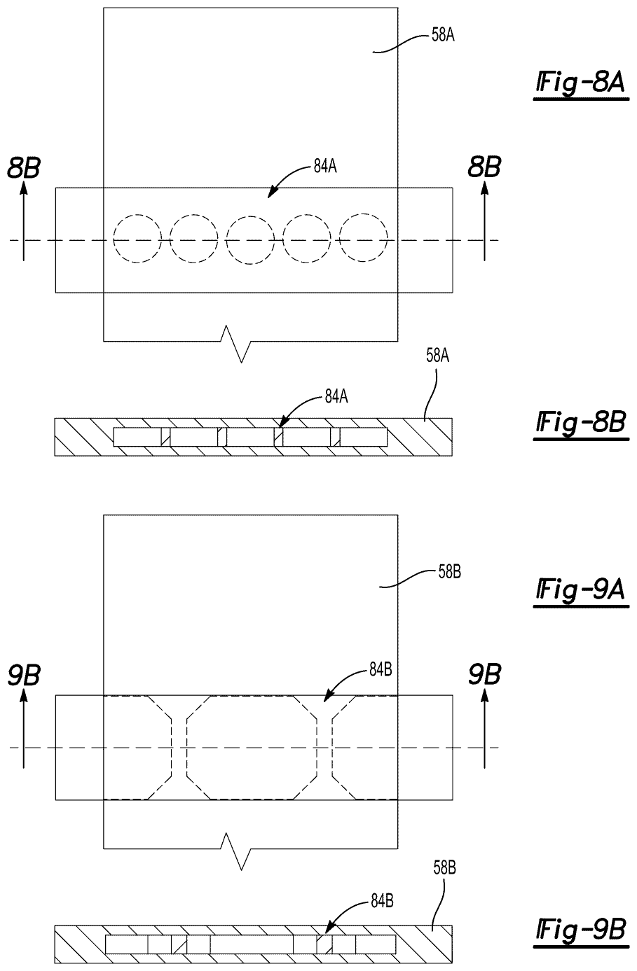

Referring to FIGS. 8A and 8B, another example frangible area 84A of a tab 58A includes five circular apertures.

Referring to FIGS. 9A and 9B, another example frangible area 84B of a tab 58B includes three apertures, two of which are slots that open to sides of the tab 58B.

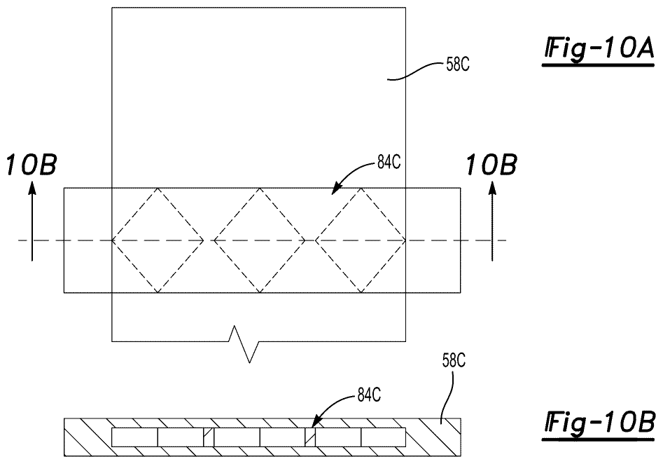

Referring to FIGS. 10A and 10B, another example frangible area 84C of a tab 58C includes three apertures having diamond-shaped profiles.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A battery assembly, comprising:
a case containing an electrode structure of a battery;
a tab that electrically couples the electrode structure to a device outside the case, the tab extending from an interior of the case to an outside of the case, the tab including a frangible area; and
a tab film covering at least the frangible area of the tab.

2. The battery assembly of claim 1, wherein the frangible area includes a plurality of apertures that extend through a thickness of the tab.

3. The battery assembly of claim 2, wherein each aperture within the plurality of apertures has a diamond-shaped profile.

4. The battery assembly of claim 1, wherein the electrode structure is sealed within the case.

5. The battery assembly of claim 1, wherein the frangible area provides a fuse.

6. The battery assembly of claim 1, wherein the frangible area is completely covered by the tab film.

7. The battery assembly of claim 1, wherein the tab film is polypropylene.

8. The battery assembly of claim 1, wherein the frangible area is sandwiched by the tab film.

9. The battery assembly of claim 1, wherein the device outside the case is a busbar of a traction battery pack.

10. The battery assembly of claim 1, wherein the frangible area comprises an array of apertures extending through the tab.

11. The battery assembly of claim 1, wherein the frangible area is configured to rupture in response to a current above a threshold current.

12. The battery assembly of claim 1, wherein the frangible area is configured to rupture to interrupt a flow of current through the tab.

13. The battery assembly of claim 1, wherein the frangible area comprises at least one slot opening to a side of the tab.

14. The battery assembly of claim 1, wherein the tab is a positive tab.

15. The battery assembly of claim 1, wherein the battery is a pouch-style battery.

16. A battery circuit interruption method, comprising:
routing a flow of current through a tab of a battery, the tab connecting an electrode of the battery that is within a case of the battery to an electrical component that is outside the case; and
covering a frangible area of the tab with a tab film, the frangible area configured to rupture to disrupt the flow of current through the tab in response to an overcurrent condition.

17. The battery circuit interruption method of claim 16, wherein the frangible area is completely covered by the tab film.

18. The battery circuit interruption method of claim 16, wherein the battery is a pouch-style battery.

19. The battery circuit interruption method of claim 16, wherein the frangible area comprises an area of the tab having a plurality of apertures.

20. The battery circuit interruption method of claim 19, wherein the plurality of apertures each extend through a thickness of the tab.
